(19) United States
(12) Patent Application Publication
(10) Pub. No.: US 2020/0342409 A1
(43) Pub. Date: Oct. 29, 2020

(54) METHOD, APPARATUS, AND SYSTEM FOR PROVIDING A DISTANCE METRIC FOR SKILL OR FEATURE DATA OF A TALENT PLATFORM

(71) Applicant: HERE GLOBAL B.V., Eindhoven (NL)

(72) Inventor: Dongwook JANG, Lisle, IL (US)

(21) Appl. No.: 16/393,730

(22) Filed: Apr. 24, 2019

(51) Int. Cl. G06Q 10/10; G06N 20/00

(52) U.S. Cl. CPC G06Q 10/1053; G06N 20/00

(57) ABSTRACT

An approach is provided for a distance metric for skill or feature data of a talent platform. The approach, for example, involves determining a first skill feature and a second skill feature from talent platform data. The talent platform data includes a plurality of data records storing a plurality of skills associated with a plurality of users. The approach also involves determining a count of the plurality of users that individually share both the first skill feature and the second skill feature. The approach further involves computing the distance metric to indicate a distance between the first skill feature and the second skill feature based on the determined count of the plurality of users.

### BACKGROUND

A talent platform (e.g., a computer system that stores and manages data on skills possessed by individuals or users) historically has been used to match candidates to potential jobs or opportunities. However, comparing or matching different skills (e.g., skills such as proficiency in Java or Python, marketing, sales, etc.) to determine how closely related they are presents significant technical challenges, particularly when the skills or features are stored as free text (e.g., as is often the case when the skills are listed in electronic resumes or equivalent).

### SOME EXAMPLE EMBODIMENTS

Therefore, there is a need for a distance metric for skill or feature data of a talent platform that, for instance, can provide a quantitative measure of how closely related two skills are. In one embodiment, this quantitative distance metric can be used to train a machine learning model or classifier to predict whether candidates are likely to be suitable for an available job or opportunity.

According to one embodiment, a computer-implemented method comprises determining a first skill feature and a second skill feature from talent platform data. The talent platform data includes a plurality of data records storing a plurality of skills associated with a plurality of users. The method also comprises determining a count of the plurality of users that individually share both the first skill feature and the second skill feature. The method further comprises computing the distance metric to indicate a distance between the first skill feature and the second skill feature based on the determined count of the plurality of users.

According to another embodiment, an apparatus comprises at least one processor, and at least one memory including computer program code for one or more computer programs, the at least one memory and the computer program code configured to, with the at least one processor, cause, at least in part, the apparatus to determine a first skill feature and a second skill feature from talent platform data. The talent platform data includes a plurality of data records storing a plurality of skills associated with a plurality of users. The apparatus is also caused to determine a count of the plurality of users that individually share both the first skill feature and the second skill feature. The apparatus is further caused to compute the distance metric to indicate a distance between the first skill feature and the second skill feature based on the determined count of the plurality of users.

According to another embodiment, a non-transitory computer-readable storage medium carries one or more sequences of one or more instructions which, when executed by one or more processors, cause, at least in part, an apparatus to determine a first skill feature and a second skill feature from talent platform data. The talent platform data includes a plurality of data records storing a plurality of skills associated with a plurality of users. The apparatus is also caused to determine a count of the plurality of users that individually share both the first skill feature and the second skill feature. The apparatus is further caused to compute the distance metric to indicate a distance between the first skill feature and the second skill feature based on the determined count of the plurality of users.

According to another embodiment, an apparatus comprises means for determining a first skill feature and a second skill feature from talent platform data. The talent platform data includes a plurality of data records storing a plurality of skills associated with a plurality of users. The apparatus also comprises means for determining a count of the plurality of users that individually share both the first skill feature and the second skill feature. The apparatus further comprises means for computing the distance metric to indicate a distance between the first skill feature and the second skill feature based on the determined count of the plurality of users.

According to another embodiment, a computer-implemented method comprises receiving a request to evaluate a candidate with a first skill feature against a platform opportunity associated with a second skill feature. The method also comprises computing the distance metric to indicate a distance between the first skill feature and the second skill feature based on talent platform data indicating a number of a plurality of users who individually share the first skill feature and the second skill feature. The method further comprises generating an output evaluating the candidate against the platform opportunity based on the distance metric.

According to another embodiment, an apparatus comprises at least one processor, and at least one memory including computer program code for one or more computer programs, the at least one memory and the computer program code configured to, with the at least one processor, cause, at least in part, the apparatus to receive a request to evaluate a candidate with a first skill feature against a platform opportunity associated with a second skill feature. The apparatus is also caused to compute the distance metric to indicate a distance between the first skill feature and the second skill feature based on talent platform data indicating a number of a plurality of users who individually share the first skill feature and the second skill feature. The apparatus is further caused to generate an output evaluating the candidate against the platform opportunity based on the distance metric.

According to another embodiment, a non-transitory computer-readable storage medium carries one or more sequences of one or more instructions which, when executed by one or more processors, cause, at least in part, an apparatus to receive a request to evaluate a candidate with a first skill feature against a platform opportunity associated with a second skill feature. The apparatus is also caused to compute the distance metric to indicate a distance between the first skill feature and the second skill feature based on talent platform data indicating a number of a plurality of users who individually share the first skill feature and the second skill feature. The apparatus is further caused to generate an output evaluating the candidate against the platform opportunity based on the distance metric.

According to another embodiment, an apparatus comprises means for receiving a request to evaluate a candidate with a first skill feature against a platform opportunity associated with a second skill feature. The apparatus also comprises means for computing the distance metric to indicate a distance between the first skill feature and the second skill feature based on talent platform data indicating a number of a plurality of users who individually share the first skill feature and the second skill feature. The apparatus further comprises means for generating an output evaluating the candidate against the platform opportunity based on the distance metric.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a distance metric for skill or feature data of a talent platform, according to one embodiment;

FIG. 2 is a diagram of components of a talent platform capable of providing a distance metric for skill or feature data, according to one embodiment;

FIG. 3 is a flowchart of a process for providing a distance metric for skill or feature data of a talent platform, according to one embodiment;

FIG. 4A is a diagram of a skill-to-skill distance metric, according to one embodiment;

FIG. 4B is a diagram of a skill-to-skill-set distance metric, according to one embodiment;

FIG. 4C is a diagram of a skill-set-to-skill-set distance metric, according to one embodiment;

FIG. 5 is a diagram of a user interface for providing candidate rankings based on a skill distance metric, according to one embodiment;

FIG. 6 is a flowchart of a process for evaluating a candidate based on a skill distance metric, according to one embodiment;

FIG. 7 is a diagram of a user interface for evaluating a candidate based on a skill distance metric, according to one embodiment;

FIG. 8 is a diagram of hardware that can be used to implement an embodiment;

FIG. 9 is a diagram of a chip set that can be used to implement an embodiment; and

FIG. 10 is a diagram of a client terminal that can be used to implement an embodiment.

### DESCRIPTION OF SOME EMBODIMENTS

Examples of a method, apparatus, and computer program for providing a distance metric for skill or feature data of a talent platform are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

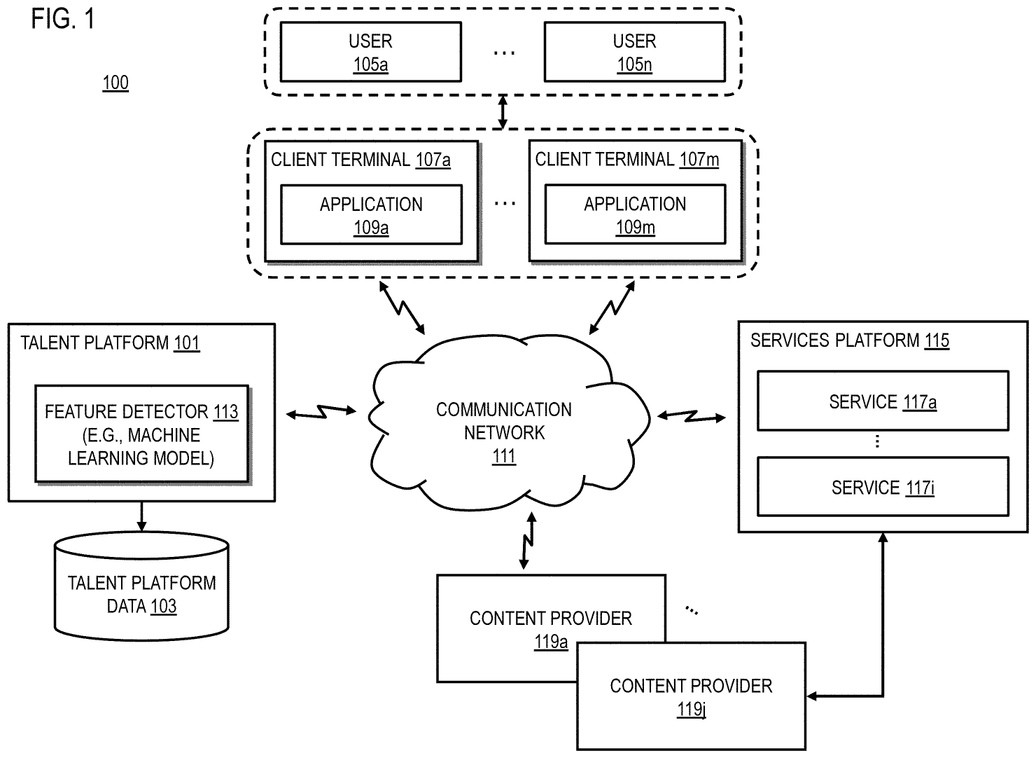

FIG. 1 is a diagram of a system capable of providing a distance metric for skill or feature data of a talent platform, according to one embodiment. Talent platforms or systems (e.g., a talent platform 101) have traditionally been used to store and manage talent platform data 103 for participating users or individuals. In one embodiment, talent platform data 103 can include data indicating skills or other related feature data (e.g., curriculum vitae (CV) data such as attended schools, affiliated organizations, certifications, training, previous/current jobs, hobbies, etc.). Skills refer, for instance, to expertise possessed by individuals. For example, an organization can collect and store the resumes or skills list of its employees, contractors, etc. as talent platform data 103. Generally, because of the unstructured nature of talent data sources (e.g., electronic resumes stored as word processing files), the resulting talent platform data 103 are also stored as free-form text that have no underlying data structure.

The free-text or unstructured nature of talent platform data 103 presents significant technical challenges to providing automated processing of talent platform data (e.g., to help employees or job seekers find relevant job or career opportunities). Skills are generally stored as unstructured text with potentially tens of thousands of different free-text labels making analysis of skill data using machine processes such as machine learning particularly challenging. Generally, to apply machine learning algorithms to text-based data, a distance metric is needed that will provide an indicator of likelihood to facilitate machine-based predictions. In particular, talent platform providers face technical challenges with respect to how to measure the distance between skills without having a semantic understanding of the skills themselves (e.g., how to measure the “distance” between proficiency with Java and proficiency with Python). This distance should be a measure how closely related any two or more skills are. For example, the distance between expertise in Java and expertise in Python should be shorter than the distance between expertise in Java and expertise in marketing. However, obtaining this semantic understanding has traditionally extensive manual labor (e.g., using human annotators to make judgements as to how close any two skills or talent platform features are to each other) and/or complex and resource intensive systems (e.g., natural language processing systems, semantic parsing systems, etc.) to determine the closeness or distance between two skills.

To address these technical challenges, the system 100 of FIG. 1 introduces a capability to define the distance metric of skills or other equivalent features in talent platform data 103. More specifically, in one embodiment, the distance of two skills is defined by the number of people who share the same two or more skills being evaluated. The number or count of people who share any two skills can then be used to quantify the distance between the two skills. For example, in the various embodiments of the distance metric described herein, the more people who share or possess two skills, the closer the distance of two skills would be. Distance, for instance, can refer to how closely related or similar two skills are to each other.

Accordingly, in one embodiment, the system 100 can define the distance metric between two skills as a quantitative value based on rules and criteria such as but not limited to:
The distance is 0 between one skill and itself;
The distance is 1/n between two skills if the two skills are shared by n number of people; and
The distance is 1 if two skills are shared by n=0 people.

In the example above, the resulting distance metric will span between the values of 0 and 1 based on the number or count of people who share the two or more skills between which the distance is being measured, with 0 being the closest distance and 1 being the furthest distance apart. It is noted that the distance range of 0 to 1 is provided by way of illustration and not as a limitation. It is contemplated the embodiments described herein can use any value range for the distance metric provided that the distance value varies inversely with the number or count of people sharing the two skills.

This distance metric provides several advantages. One advantage is that the computation of the metric, particularly when skills or related features are stored as unstructured fee text, is much less resource intensive than determining a semantic understanding of the skills from free-text to determine their distance or closeness. In other words, to determine the distance metric according to the embodiments described herein, the system need only query talent platform data 103 to count the number of individuals or persons who share the same two or more skills as opposed to performing resource intensive natural language processing to extract semantic information or performing resource intensive manual annotation.

For example, in one use case, users 105a-105n (also collectively referred to as users 105) can use client terminals 107a-107m (also collectively referred to as client terminals 107) to provide or access talent platform data 103 to the talent platform 101 over a communication network 111. The talent platform data 103 can include but is not limited to skills or other features possessed by the users 105. In general, the skills are stored as free text and can vary across any area of expertise. Examples of skills include but are not limited: Java, Java Development, Java/Scala, software development, Python, marketing, sales, human resources management, etc. In one embodiment, the system 100 can optionally preprocess the extracted skills to clean the skill data and group together similar skills prior to computing a distance. For example, similar text labels for skills such as Java and Java Development can be grouped together into one skill or category.

Referring to the example skills listed above, the distance between Java and Python should be shorter than the distance between Java and Marketing because the software development skills used for Java and Python are likely to be more similar than software development skills and marking skills based on an intuitive or semantic understanding of the skills. However, the embodiments described herein enable the system 100 to employ a distance metric based on counting the number of users sharing Java/Python versus sharing Java/Marketing or Python/Marketing to provide an indication of the distance between the skills without requiring the semantic understanding of the underlying skills.

The embodiments discussed above are about comparing one skill to another skill to compute a skill-to-skill distance metric. In one embodiment, the distance metric can be extended to the distance between a skill and a set of skills (i.e., a skill-to-skill-set distance metric) and further extended to the distance between a set of skills and another set of skills (i.e., a skill-set-to-skill-set distance metric) as described in further detail in the embodiments below.

Another advantage of the embodiments of the distance metric described herein is that the distance metric provides a quantitative representation of the similarity or closeness of skills or skill sets. Such a quantitative distance metric enables the system 100 to use the distance metric as an input feature to train machine learning models (e.g., a feature detector 113) to make predictions regarding whether one skill/skill set is likely to match another skill/skill set within a predefined matching or acceptability criteria. In this way, the system 100 enables services that, for instance, can help employees find relevant opportunities (and career path), help opportunity owners (employers) find the right employees for opportunities, or otherwise optimally associated employees/job seekers/users/etc. with talent platform opportunities/jobs/tasks/functions/etc.

It is noted that skills represented one feature of the talent platform data 103 for which the embodiments of the distance metric described herein apply. It is contemplated that the distance metric can be applied to any feature (e.g., stored as free-text) associated with individual or person data records in the talent platform data 103. Accordingly, skills and features of individuals can be used interchangeably throughout the description provided herein such that when either skills or features are discussed alone, it is contemplated that the description is applicable to both skills and features alone or in combination.

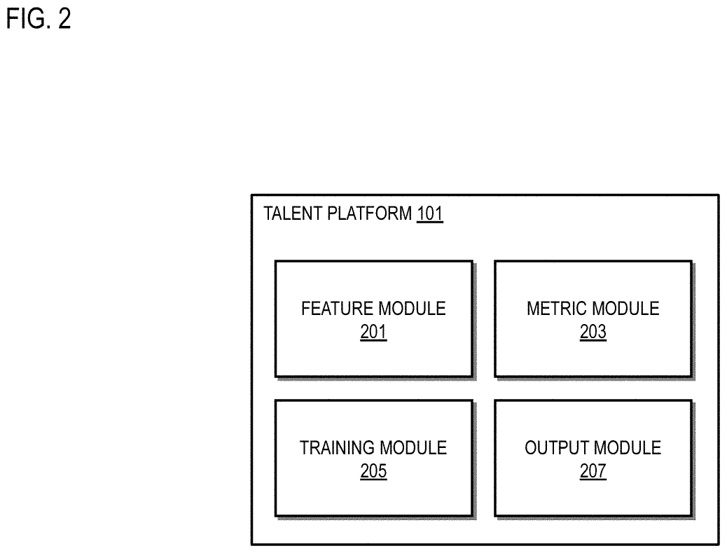

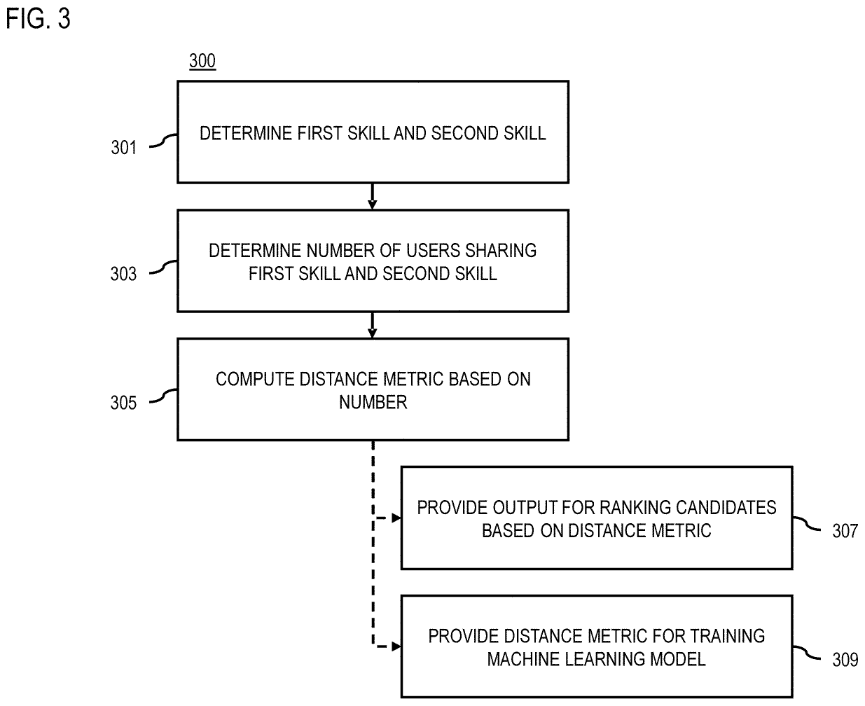

In one embodiment, as shown in FIG. 2, the talent platform 101 includes one or more components for providing a distance metric for skill or feature data, according to the various embodiments described herein. It is contemplated that the functions of these components may be combined or performed by other components of equivalent functionality. In this embodiment, the talent platform 101 includes a feature module 201, metric module 203, machine learning module 205 (e.g., a feature detector 113), and output module 207. The above presented modules and components of the talent platform 101 can be implemented in hardware, firmware, software, or a combination thereof. Though depicted as a separate entity in FIG. 1, it is contemplated that the talent platform 101 may be implemented as a module of any other component of the system 100 (e.g., a component of a services platform 115, services 117a-117i (also collectively referred to as services 117), client terminal 107, application 109 executing on the client terminal 107, etc.). In another embodiment, one or more of the modules 201-207 may be implemented as a cloud-based service, local service, native application, or combination thereof. The functions of the talent platform 101 and the modules 201-207 are discussed with respect to FIGS. 3-7 below.

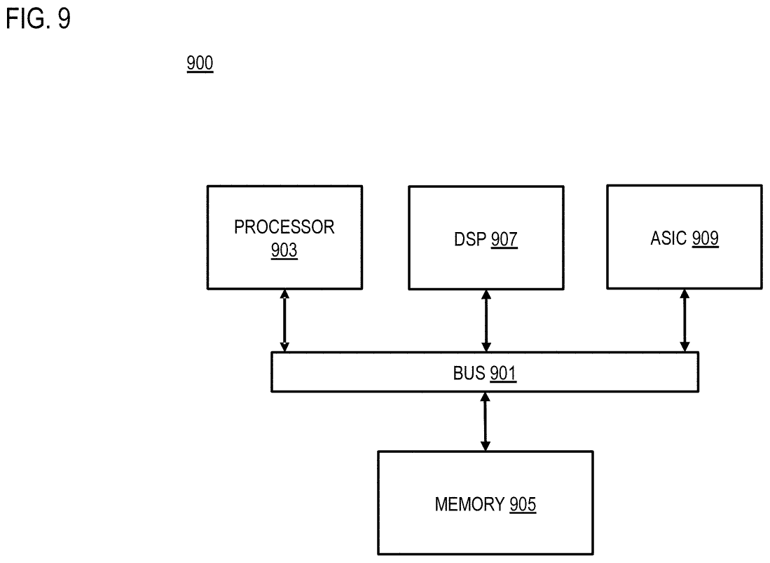

FIG. 3 is a flowchart of a process for providing a distance metric for skill or feature data of a talent platform, according to one embodiment. In various embodiments, the talent platform 101 and/or any of the modules 201-207 of the talent platform 101 may perform one or more portions of the process 300 and may be implemented in, for instance, a chip set including a processor and a memory as shown in FIG. 9. As such, the talent platform 101 and/or the modules 201-207 can provide means for accomplishing various parts of the process 300, as well as means for accomplishing embodiments of other processes described herein in conjunction with other components of the system 100. Although the process 300 is illustrated and described as a sequence of steps, its contemplated that various embodiments of the process 300 may be performed in any order or combination and need not include all of the illustrated steps.

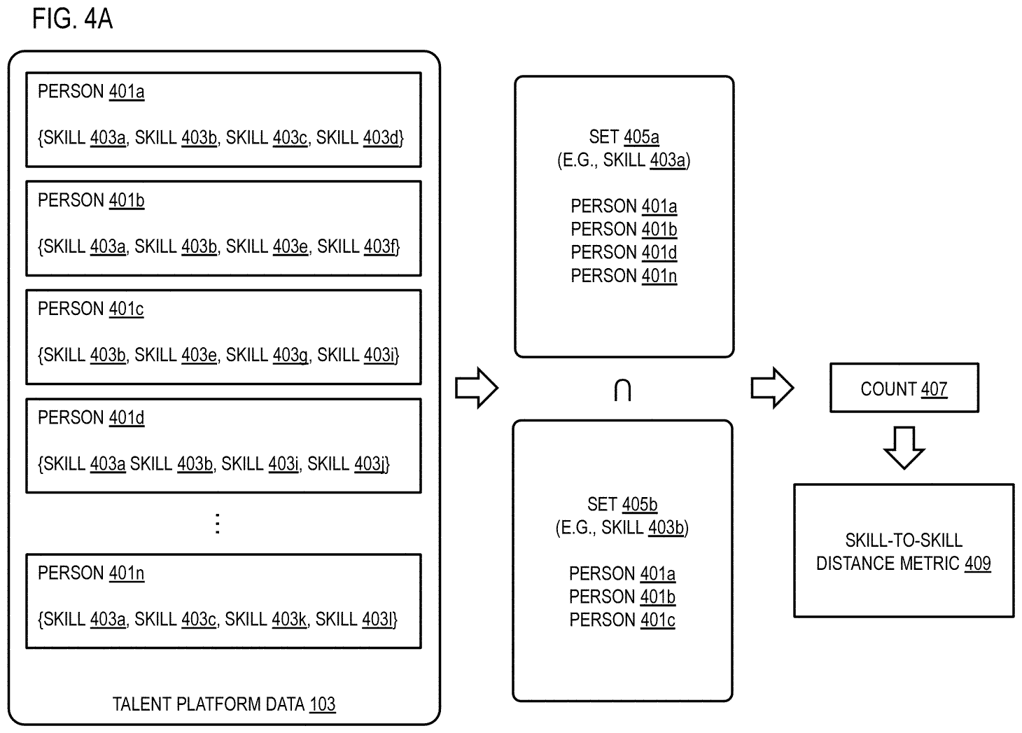

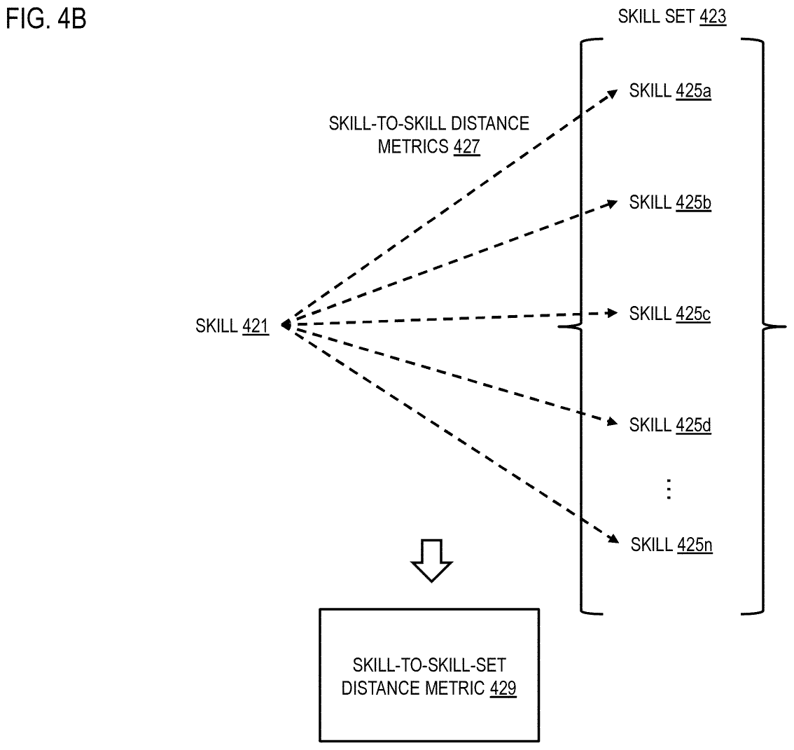

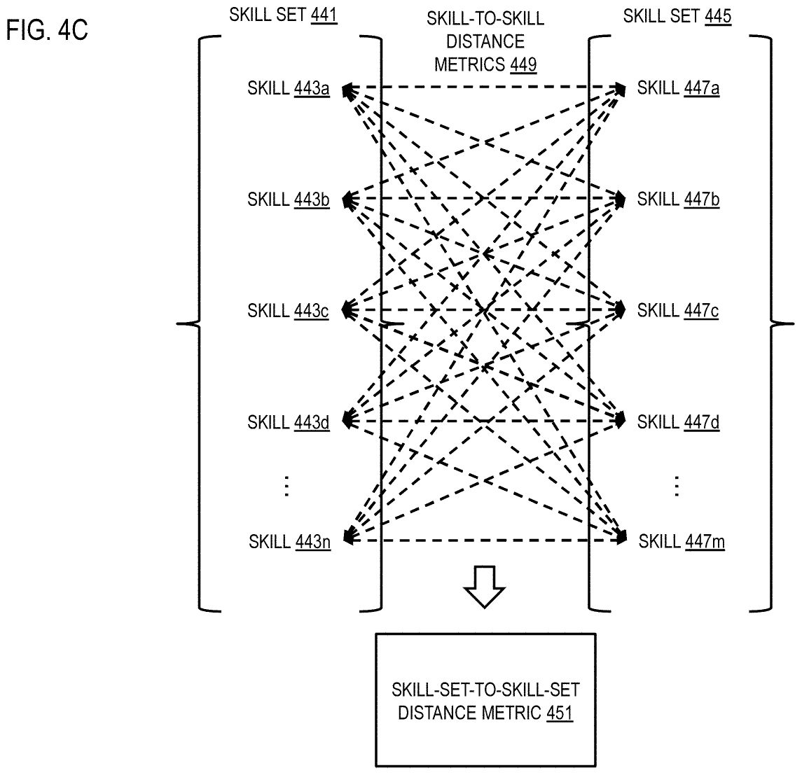

In step 301, the feature module 201 determines a first skill feature and a second skill feature from the talent platform data 103. In one embodiment, the talent platform data 103 includes a plurality of data records storing a plurality of skills associated with a plurality of users. In one embodiment as discussed above, the skill data (e.g., the first skill feature, the second skill feature, or a combination thereof) is stored in the talent platform data 103 as free or unstructured text. In the example of FIG. 4A, talent platform data 103 includes a plurality of person data records 401a-401n (also collectively referred to as persons 401) that store a listing of skills (e.g., various combinations of skills 403a-4031, also collectively referred to as skills 403). Each person data record 401 can be identified with a person identifier (person_id).

In step 303, the metric module 203 determines a count of the plurality of users that individually share both the first skill feature and the second skill feature between which the distance is being measured. For example, let sᵢ be the set of person_id's for an i^{th} skill, sⱼ be the set of person_id for a j^{th} skill, and nᵢⱼ be the count or number of persons common in sᵢ and sⱼ. Then, nᵢⱼ can be computed as illustrated but not limited to the following:

nᵢⱼ=n(sᵢ∩sⱼ)

where n(sᵢ∩sⱼ) is the number or count of members of intersection set between sᵢ and sⱼ.

This process can be illustrated with respect to the example of FIG. 4A. For example, if the distance between skills 403a and 403b is to be measured, the metric module 201 extracts or queries for persons 401 having skill 403a to create a first set 405a of persons 401 (e.g., persons 401a, 401b, 401d, and 401n) and queries for persons 401 having skill 403b to create a second set 405b of persons 401 (e.g., persons 401a, 401b, and 401c). The metric module 203 can then determine a count 407 of persons 401 contained in the intersection of sets 405a and 405b, which can be used for computing a skill-to-skill distance metric 409 as described below.

In step 305, the metric module 201 computes the distance metric to indicate a distance between the first skill feature and the second skill feature based on the determined count of the plurality of users. In one embodiment, the skills are compared on a per skill basis to compute a skill-to-skill distance between to two skills. For example, let d(sᵢ, sⱼ) or dᵢⱼ be the skill-to-skill distance metric between two skills (sᵢ, sⱼ). In one embodiment, the skill-to-skill distance metric can then be computed as illustrated but not limited to the following:

$$d ( {s}_{i} , {s}_{j} ) = {d}_{i j} = \{ \begin{matrix}0 & if {s}_{i} = {s}_{j} \\ 1 & if {n}_{i j} = 0 \\ \frac{1}{{n}_{i j}} & otherwise\end{matrix}$$

As previously discussed, the rationale behind this definition is to measure how many people share the same skills in common. The measure or count of how many people share the same two skills can be determine with less computational requirements than parsing and then determining the semantic relationship between the two skills. For example, under embodiments of the distance metric described herein, more people sharing the same two skills will result in a lower distance value (dᵢⱼ), thereby indicating that the two skills are correspondingly “closer” in distance than another pair of skills that have fewer or no number of people having the same two skills.

As illustrated above, in one embodiment, the distance metric is inversely related to the determined number of plurality of users who share or have two skills in common that are being compared or measured. In yet another embodiment, the distance metric is normalized to a value between a predetermined value range such as but not limited to a range from 0 (closest distance) to 1 (farther distance).

It is noted that the example equation illustrated above is provided only as one possible example. For example,

$$\frac{1}{{n}_{t j}}$$

is an example function in one simple form. Any function can be used according to the embodiments described herein provided the function exhibits one or more of the following properties for the distance metric:
The larger the nᵢⱼ, the smaller dᵢⱼ; and/or
The skill distance should be normalized to a specified range (e.g., between 0 and 1).

In one embodiment, the distance metric can be calculated as a skill-to-skill-set distance when the talent platform 101 is computing the distance between an individual skill and a set of skills (e.g., a set of skills associated with a job or opportunity). For example, lets be a skill and S a set of skills. In one embodiment, the distance between a skill and a set of skills (i.e., the skill-to-skill-set distance metric, denoted by d(s, S)) can be computed as the minimum skill-to-skill distance between the skill and one skill in the skill set as illustrated but not limited to the following:

d(s,S)=arg min d(s,sᵢ)

where sᵢ is an element in S.

In other words, when determining a distance metric between a first skill and a second skill, wherein the second skill feature is part of a skill feature set comprising a plurality of skill features, the metric module 203 can compute a skill-to-skill-set distance metric to indicate a distance between the first skill feature and the skill feature set based on the distance metric between the first skill feature and the second skill feature. For example, the skill-to skill-set distance metric is set equal to the distance metric between the first skill feature the second skill feature based on determining that the distance metric between the first skill feature and the second skill feature indicates a minimum distance to the first skill feature among the plurality of skill features in the skill feature set. It is noted that the minimum distance is only one way to determine a skill-to-skill-set distance metric, and any other selection criteria or rule (e.g., maximum distance, mean distance, median distance, distance for a selected key skill(s), etc.) can be used to determine the skill-to-skill-set distance from a set of skill-to-skill distances.

An example of computing a skill-to-skill-set distance metric is shown in FIG. 4B, according to one embodiment. In the example of FIG. 4B, a distance between a skill 421 and a skill set 423 comprising skills 425a-425n (also collectively referred to as skills 425) is being measure. The skill 421 can be a skill possessed by an individual that is being compared to a job opportunity associated with the skill set 423. The metric module 203 can compute respective skill-to-skill distance metrics 427 between the skill 421 and each of the skills 425 of the skill set 423 according to the embodiments described above. The metric module 203 can then determine the minimum distance (or maximum, median, mean, etc. depending on the application) among the skill-to-skill distance metrics 427 to set as the skill-to-skill-set distance metric 429 between skill 421 and skill set 423.

In one embodiment, the distance metric can be calculated as a skill-set-to-skill-set distance when the talent platform 101 is computing the distance between a first set of skills and a second set of skills. For example, let S and T be different sets of skills. The distance between the two skill sets (d(S, T)) can be defined as a mean of individual skill-to-skill distances between a skill in S and T as illustrated but not limited to the following:

$$d ( S , T ) = \frac{1}{n} {\sum }_{i} d ( {s}_{i} , T )$$

where sᵢ is an element in S and n is the number of elements in S.

In other words, when computing a distance metric between a first skill and a second skill, wherein the first skill feature is part of a first skill feature set comprising a first plurality of skill features and the second skill feature is part of a second skill feature set comprising a second plurality of skill features, the metric module 203 can compute a skill-set-to-skill-set distance metric to indicate a distance between the first skill feature set and the second skill feature set based on a plurality of distance metrics computed between the first plurality of skill features and the second plurality of skill features. In one embodiment, the skill-set-to-skill-set distance metric is computed as a mean, median, maximum, minimum, etc. of the plurality of distance metrics.

An example of computing a skill-set-to-skill-set distance metric is shown in FIG. 4C, according to one embodiment. In the example of FIG. 4C, a distance between a skill set 441 comprising skills 443a-443n (also collectively referred to as skills 443) and a skill set 445 comprising skills 447a-447m (also collectively referred to as skills 447) is being measure. The skill set 441 can be a set of the skills 443 possessed by an individual that is being compared to a job opportunity associated with the skill set 445. The metric module 203 can compute respective skill-to-skill distance metrics 449 between each of the skills 443 of the skill set 441 and each of the skills 447 of the skill set 445 according to the embodiments described above. The metric module 203 can then determine the mean, median, maximum, minimum, etc. distance of the skill-to-skill distance metrics 449 to set as the skill-set-to-skill-set distance metric 451 between skill set 441 and skill set 445.

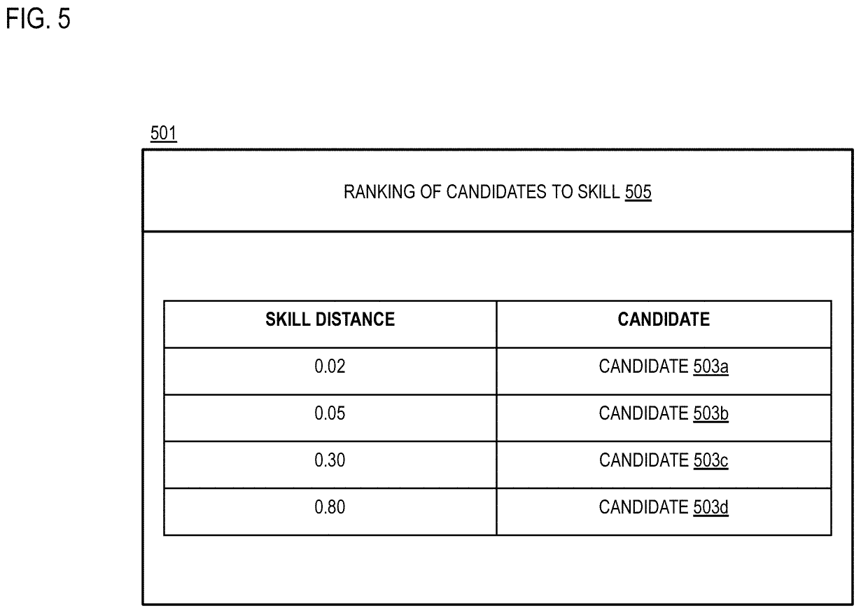

In one embodiment, the talent platform 101 can optionally use the computed distance metric for any number of applications. For example, in step 307, the output module 207 can provide an output comprising a ranking of candidate users based on the distance metric. An example of such an output is shown in the user interface (UI) 501 of FIG. 5. In this example, the talent platform 101 has been requested to rank a group of candidates 503a-503d (also collectively referred to as candidates 503) with respect to their skill distance to a skill 505 of interest. The ranking request can specify the skills possessed by the candidates 503. In addition or alternatively, the talent platform 101 can retrieve skill data (e.g., indicating one skill each) for the respective candidates 503 from the talent platform data 103 if available. The skill-to-skill distance metric between skill 505 of interest and the candidates 503's respective skill can be computed. The UI 501 then presents a ranking of the candidates based on the computed skill distance that lists the candidates 503 in order of their distance to skill 505 as shown.

In another example, in step 309, the feature detector 113 can provide the distance metric as an input feature for training or using a machine learning model to process the talent platform data 103. As discussed above, to apply machine learning algorithms to text-based data such as skill or feature data, the talent platform 101 can compute a distance metric according to embodiments described an indicator of the probability or likelihood of the closeness of two or more skills. The machine learning model (e.g., neural network, support vector machine, etc.) can then be trained or constructed to associate and rank employees with opportunities or jobs based on the distance metric.

In one embodiment, the feature detector 113 of the talent platform 101 can be used to train machine learning models or algorithms to make predictions or classifications based on the distance metric. For example, the feature detector 113 can obtain or be provided with training data that includes ground truth skill distance metrics correlated with ground truth features or classifications to are to be predicted based on the distance metrics (e.g., user association or suitability for an opportunity or job). The feature detector 113 can present this ground truth data to a machine learning model during training using, for instance, supervised deep convolutional networks or equivalent. In other words, a machine learning model can be trained using the ground truth distance metric data. Generally, a machine learning model (e.g., a neural network, set of equations, rules, decision trees, etc.) is trained to manipulate an input feature set to make a prediction about the feature set or the phenomenon/observation that the feature set represents. In one embodiment, the training features for the machine learning model include the skill distance metrics computed according to the embodiments described herein.

In one embodiment, the feature detector 113 can incorporate a supervised learning model (e.g., a logistic regression model, RandomForest model, and/or any equivalent model) to train a machine learning model using the ground truth data. For example, during training, the feature detector 113 uses a learner module that feeds distance metric observations and related feature sets into the machine learning model to compute a predicted feature set (e.g., predicted user rankings or associations with jobs or opportunities) using an initial set of model parameters.

The learner module then compares the predicted feature set to the ground truth data (e.g., known user associations with jobs or opportunities with known skill distance metrics). For example, the learner module computes a loss function representing, for instance, an accuracy of the predictions for the initial set of model parameters. In one embodiment, the learner module computes a loss function for the training of the machine learning model based on the ground truth images. The learner module then incrementally adjusts the model parameters until the model minimizes the loss function (e.g., achieves a maximum accuracy with respect to the manually marked labels). In other words, a “trained” feature prediction model is a classifier with model parameters adjusted to make accurate predictions with respect to the ground truth data.

Once trained on ground truth skill distance metric data, the feature detector 113 can use the trained machine learning to make predictions for subsequently determined user skill distance metrics that have no known correspondence or associations with potential jobs or opportunities (e.g., jobs or opportunities associated with respective skill or skill set requirements). In one embodiment, the trained feature detector 113 can be used to evaluate potential candidates based on skill distance metrics as described in more detail below.

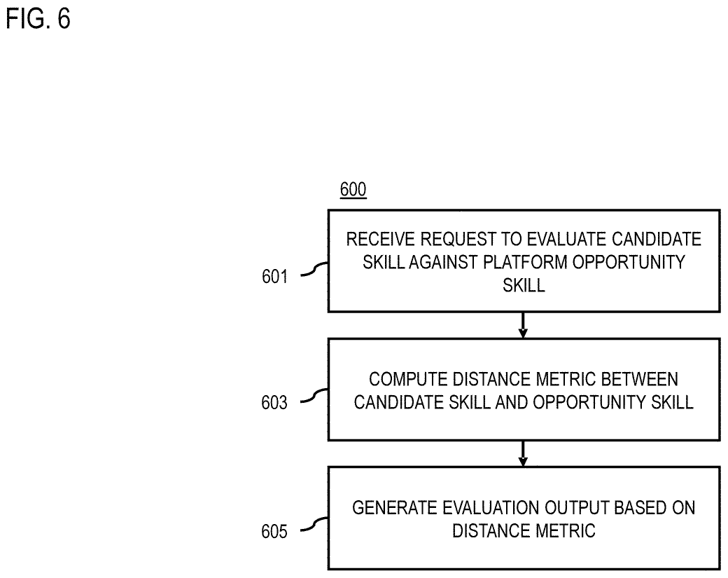

FIG. 6 is a flowchart of a process for evaluating a candidate based on a skill distance metric, according to one embodiment. In various embodiments, the talent platform 101 and/or any of the modules 201-207 of the talent platform 101 may perform one or more portions of the process 600 and may be implemented in, for instance, a chip set including a processor and a memory as shown in FIG. 9. As such, the talent platform 101 and/or the modules 201-207 can provide means for accomplishing various parts of the process 600, as well as means for accomplishing embodiments of other processes described herein in conjunction with other components of the system 100. Although the process 600 is illustrated and described as a sequence of steps, its contemplated that various embodiments of the process 600 may be performed in any order or combination and need not include all of the illustrated steps.

In step 601, the feature module 201 receives a request to evaluate a candidate with a first skill feature against a platform opportunity associated with a second skill feature. For example, the requests can be initiated to help the candidate find jobs or opportunities available in the talent platform 101 or to help employers find candidates to fill their available jobs or opportunities.

In step 603, the metric module 203 computes the distance metric to indicate a distance between the first skill feature and the second skill feature according to the embodiments described herein. For example, as described above, the computed distance metric can be based on talent platform data indicating a number or count of a plurality of users who individually share the first skill feature and the second skill feature. In other words, the computed distance metric is based on how many people possess the two skills that are being measure, with the rationale being that two skills are closer in distance if more people have both skills. Depending on the application and available talent data, the distance metric can be computed as a skill-to-skill distance metric, skill-to-skill-set distance metric, skill-set-to-skill-set distance metric, or a combination thereof.

In step 605, the output module 207 generates an output evaluating the candidate against the platform opportunity based on the computed distance metric. In one embodiment, the evaluation can include comparing the computed distance metric between a user's skill and an opportunity's skill requirement against a threshold distance. For example, a computed distance metric that is less than the threshold distance indicates that the candidate may be suitable for the opportunity, while a computed distance that is greater than the threshold distance indicates that the candidate may not be suitable for the opportunity. The employer or opportunity employer can set the threshold distance based on how closely the want candidates to match the skill requirements for the opportunity to be considered suitable. In another embodiment, the distance threshold can be learned through analysis of employment data correlating a user's distance metric while a candidate for an opportunity against whether the user was ultimately selected or not selected for the opportunity.

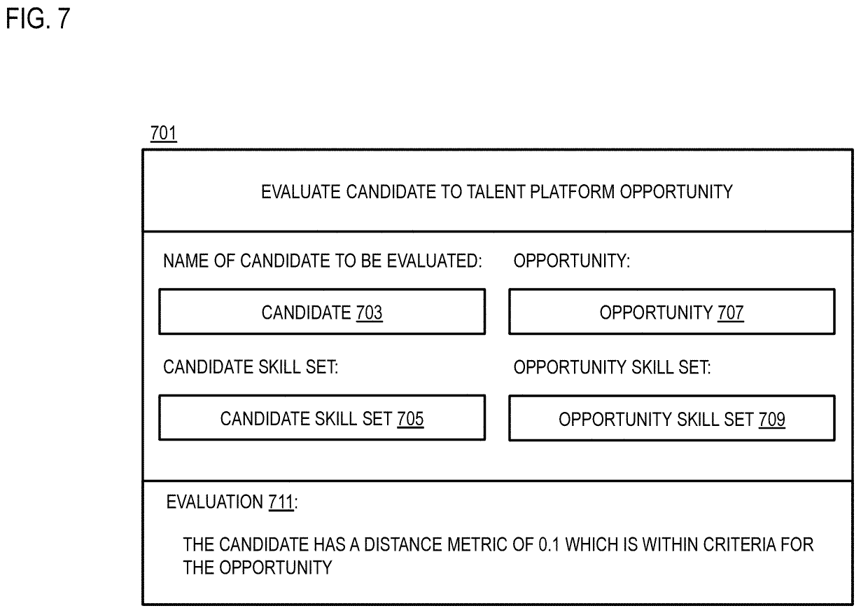

FIG. 7 is a diagram of a user interface (UI) 701 for evaluating a candidate based on a skill distance metric, according to one embodiment. In the example of FIG. 7, the UI 701 provides input elements for specifying a candidate 703 possessing a candidate skill set 705 to evaluate against an opportunity 707 associated with an opportunity skill set 709 (e.g., indicating a set of skills that the opportunity provider would like in a successful candidate). Based on the input data, the talent platform 101 computes a skill-set-to-skill-set distance metric between the candidate skill set 705 and the opportunity skill set 709. The talent platform 101 then evaluates the computed skill-set-to-skill-set distance metric against a distance threshold or criterion to determine whether the candidate 703 is suitable for the opportunity 707. In this case, the computed distance metric is within the threshold distance. The talent platform 101 can then generate an output evaluation 711 (e.g., a message indicating “The candidate has a distance metric of 0.1 which is within criteria for the opportunity) and presents the evaluation 711 in the UI 701.

Returning to FIG. 1, as shown, the talent platform 101 has connectivity over a communication network 111 to a services platform 115 that provides one or more services 117a-117i (also collectively referred to as services 117) based on the skill or feature distance metric computed according to the embodiments described herein. By way of example, the services 117 may be third party services and include talent services, job services, mapping services, navigation services, travel planning services, notification services, social networking services, content (e.g., audio, video, images, etc.) provisioning services, application services, storage services, contextual information determination services, location based services, information based services (e.g., weather, news, etc.), etc.

In one embodiment, the talent platform 101 may be a platform with multiple interconnected components. The talent platform 101 may also include multiple servers, intelligent networking devices, computing devices, components and corresponding software for providing a distance metric for skill or feature data. In addition, it is noted that the talent platform 101 may be a separate entity of the system 100, a part of the one or more services 117, a part of the services platform 115, or included within the client terminal 107.

In one embodiment, content providers 119a-119j (collectively referred to as content providers 119) may provide content or data (e.g., including talent platform data, skill data, feature data, opportunity data, etc.) to the talent platform 101, talent platform database 103, feature detector 113, services platform 115, the services 117, client terminal 107, and/or an application 109. The content provided may be any type of content, such as talent or skill content, textual content, audio content, video content, image content, etc. In one embodiment, the content providers 119 may provide content that may aid in the providing a distance metric for skill or feature data. In one embodiment, the content providers 119 may also store content associated with the talent platform 101, talent platform data 103, and/or client terminal 107. In another embodiment, the content providers 119 may manage access to a central repository of data, and offer a consistent, standard interface to data, such as a repository of the talent platform data 103.

In one embodiment, the client terminal 107 may execute a software application 109 to provide a distance metric for skill or feature data or use the output of the talent platform 101 to perform one or more functions. By way of example, the application 109 may also be any type of application that is executable on the client terminal 107 including but not limited to native applications, web-based applications, widgets, and/or the like. In one embodiment, the application 109 may act as a client for the talent platform 101 perform one or more functions associated with providing a distance metric alone or in combination with the talent platform 101.

By way of example, the client terminal 107 is any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the client terminal 107 can support any type of interface to the user (such as “wearable” circuitry, etc.).

In one embodiment, the communication network 111 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the talent platform 101, client terminal 107, services platform 115, services 117, and/or content providers 119 communicate with each other and other components of the system 100 using well known, new or still developing protocols. In this context, a protocol includes a set of rules defining how the network nodes within the communication network 111 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

The processes described herein for providing a distance metric for skill or feature data of a talent platform may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

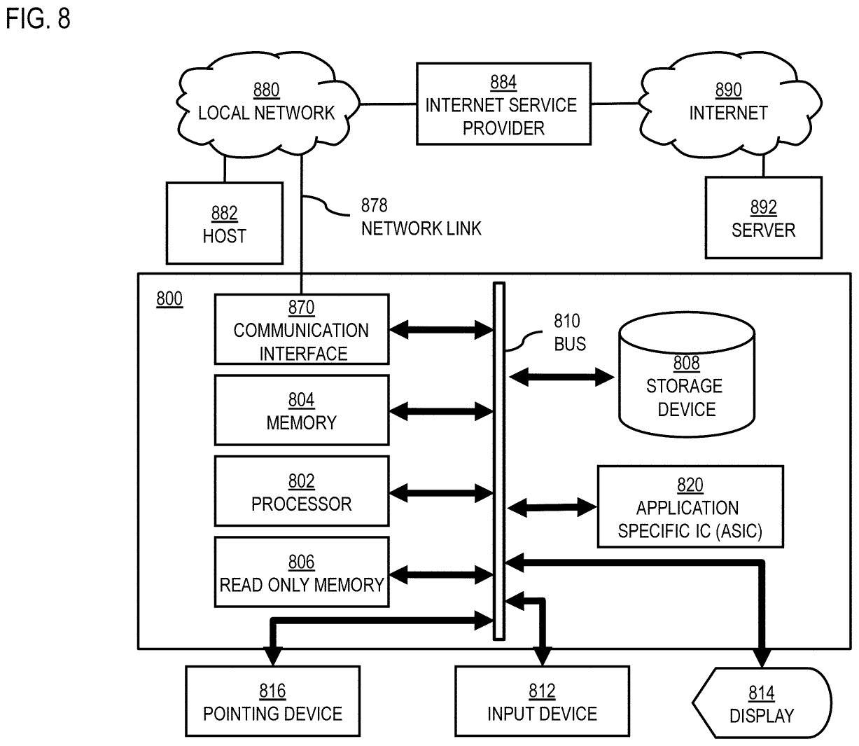

FIG. 8 illustrates a computer system 800 upon which an embodiment of the invention may be implemented. Computer system 800 is programmed (e.g., via computer program code or instructions) to provide a distance metric for skill or feature data of a talent platform as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to providing a distance metric for skill or feature data of a talent platform. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for providing a distance metric for skill or feature data of a talent platform. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing a distance metric for skill or feature data of a talent platform, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 111 for providing a distance metric for skill or feature data of a talent platform.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 9 illustrates a chip set 900 upon which an embodiment of the invention may be implemented. Chip set 900 is programmed to provide a distance metric for skill or feature data of a talent platform as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide a distance metric for skill or feature data of a talent platform. The memory 905 also stores the data associated with or generated by the execution of the inventive steps.

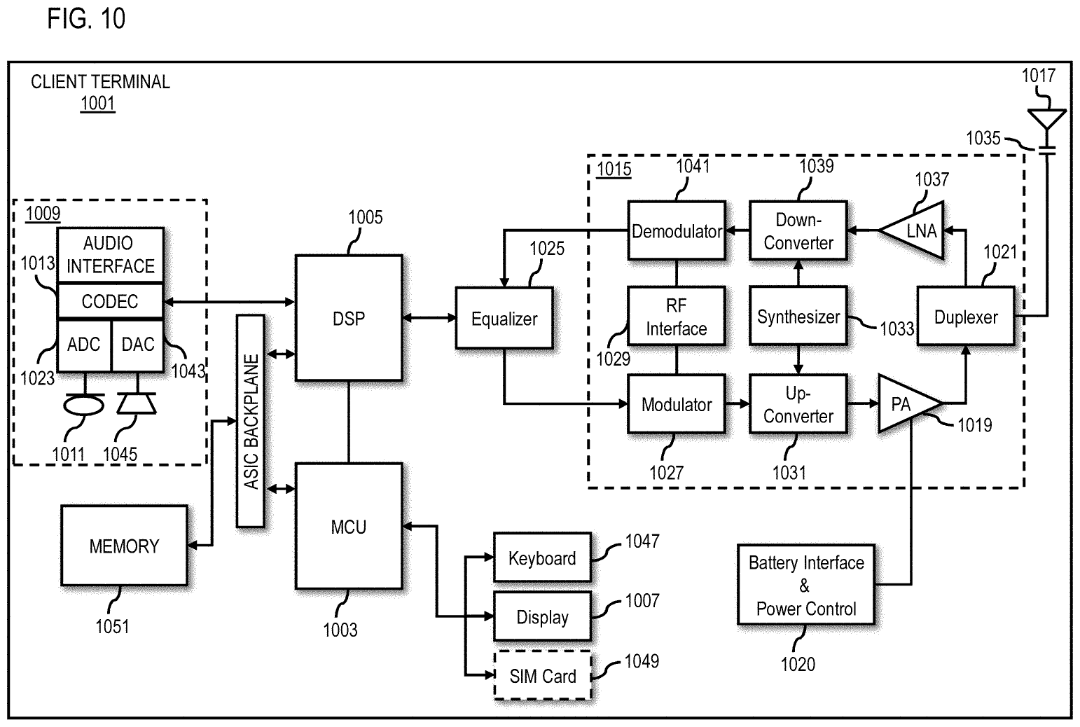

FIG. 10 is a diagram of exemplary components of a client terminal 1001 (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of client terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the client terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the client terminal 1001 to provide a distance metric for skill or feature data of a talent platform. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the client terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the client terminal 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method for generating a distance metric for skill data of a talent platform comprising:
determining a first skill feature and a second skill feature from talent platform data, wherein the talent platform data includes a plurality of data records storing a plurality of skills associated with a plurality of users;
determining a count of the plurality of users that individually share both the first skill feature and the second skill feature; and
computing the distance metric to indicate a distance between the first skill feature and the second skill feature based on the determined count of the plurality of users.

2. The method of claim 1, further comprising:
providing an output comprising a ranking of candidate users based on the distance metric.

3. The method of claim 1, further comprising:
providing the distance metric as an input feature for training a machine learning model to process the talent platform data.

4. The method of claim 1, wherein the second skill feature is part of a skill feature set comprising a plurality of skill features, the method further comprising:
computing a skill-to-skill-set distance metric to indicate a distance between the first skill feature and the skill feature set based on the distance metric between the first skill feature and the second skill feature.

5. The method of claim 4, wherein the skill-to skill-set distance metric is set equal to the distance metric between the first skill feature the second skill feature based on determining that the distance metric between the first skill feature and the second skill feature indicates a minimum distance to the first skill feature among the plurality of skill features in the skill feature set.

6. The method of claim 1, wherein the first skill feature is part of a first skill feature set comprising a first plurality of skill features and the second skill feature is part of a second skill feature set comprising a second plurality of skill features, the method further comprising:
computing a skill-set-to-skill-set distance metric to indicate a distance between the first skill feature set and the second skill feature set based on a plurality of distance metrics computed between the first plurality of skill features and the second plurality of skill features.

7. The method of claim 6, wherein the skill-set-to-skill-set distance metric is computed as a mean of the plurality of distance metrics.

8. The method of claim 1, wherein the distance metric is inversely related to the determined number of plurality of users.

9. The method of claim 1, wherein the distance metric is normalized to a value between a predetermined value range.

10. The method of claim 1, wherein the first skill feature, the second skill feature, or a combination thereof is stored in the talent platform data as free text.

11. An apparatus for generating a distance metric for feature data of a talent platform comprising:
at least one processor; and
at least one memory including computer program code for one or more programs,
the at least one memory and the computer program code configured to, with the at least one processor, cause the apparatus to perform at least the following,
receiving a request to evaluate a candidate with a first skill feature against a platform opportunity associated with a second skill feature;
computing the distance metric to indicate a distance between the first skill feature and the second skill feature based on talent platform data indicating a number of a plurality of users who individually share the first skill feature and the second skill feature; and
generating an output evaluating the candidate against the platform opportunity based on the distance metric.

12. The apparatus of claim 11, wherein the output includes a ranking of the candidate against one or more other candidates based on the distance metric.

13. The apparatus of claim 11, wherein the apparatus is caused to:
provide the distance metric as an input feature for a machine learning model to generate the output.

14. The apparatus of claim 11, wherein the second skill feature is part of a skill feature set comprising a plurality of skill features associated with the platform opportunity, and wherein the apparatus is further caused to:
compute a skill-to-skill-set distance metric to indicate a distance between the first skill feature and the skill feature set based on the distance metric between the first skill feature and the second skill feature.

15. The apparatus of claim 11, wherein the first skill feature is part of a first skill feature set comprising a first plurality of skill features associated with the candidate and the second skill feature is part of a second skill feature set comprising a second plurality of skill features associated with the platform opportunity, and wherein the apparatus is further caused to:
compute a skill-set-to-skill-set distance metric to indicate a distance between the first skill feature set and the second skill feature set based on a plurality of distance metrics computed between the first plurality of skill features and the second plurality of skill features.

16. A non-transitory computer-readable storage medium for generating a distance metric for feature data of a talent platform, carrying one or more sequences of one or more instructions which, when executed by one or more processors, cause an apparatus to perform:
determining a first feature and a second feature from talent platform data, wherein the talent platform data includes a plurality of data records storing a plurality of features associated with a plurality of users;
determining a count of the plurality of users that individually share both the first feature and the second feature; and
computing the distance metric to indicate a distance between the first feature and the second feature based on the determined count of the plurality of users.

17. The non-transitory computer-readable storage medium of claim 16, wherein the first feature, the second feature, the plurality of features, or a combination thereof includes a skill feature indicating one or more skills possessed by the plurality of users.

18. The non-transitory computer-readable storage medium of claim 16, wherein the apparatus is caused to further perform:
providing an output comprising a ranking of candidate users based on the distance metric.

19. The non-transitory computer-readable storage medium of claim 16, wherein the second feature is part of a feature set comprising a plurality of features, and wherein the apparatus is caused to further perform:
computing a feature-to-feature-set distance metric to indicate a distance between the first feature and the feature set based on the distance metric between the first feature and the second feature.

20. The non-transitory computer-readable storage medium of claim 16, wherein the first feature is part of a first feature set comprising a first plurality of features and the second feature is part of a second feature set comprising a second plurality of features, and wherein the apparatus is caused to further perform:
computing a feature-set-to-feature-set distance metric to indicate a distance between the first feature set and the second feature set based on a plurality of distance metrics computed between the first plurality of features and the second plurality of features.
